(19) United States
(12) Patent Application Publication
(10) Pub. No.: US 2016/0219058 A1
(43) Pub. Date: Jul. 28, 2016

(54) SYSTEM AND METHOD FOR FILE SHARING

(71) Applicant: ASCAN CORP.,LTD., Gyeonggi-do (KR)

(72) Inventor: Yong Seop KIM, Gyeonggi-do (KR)

(73) Assignee: ASCAN CORP.,LTD., Gyeonggi-do (KR)

(21) Appl. No.: 14/875,556

(22) Filed: Oct. 5, 2015

(30) Foreign Application Priority Data
Jan. 23, 2015 (KR) 10-2015-0011455

(51) Int. Cl. H04L 29/06; G06F 21/62; G06F 21/60; H04L 29/08

(52) U.S. Cl. CPC H04L 63/102; H04L 67/06; G06F 21/6218; G06F 21/602

(57) ABSTRACT

A file sharing system may comprise a server configured to store a sharing file having one or more versions and an identifier of the sharing file, receive the sharing file and the identifier of the sharing file from one or more devices, and determine a version of the received sharing file corresponding to the identifier of the sharing file by using a hash value of the sharing file and a time editing the sharing file. A file sharing method may comprise sending, by a server, one or more messages associated with a sharing file to one or more devices which store the sharing file and have authorization to access the messages associated with the sharing file.

### CROSS-REFERENCE TO RELATED APPLICATION

This application claims priority from Korean Patent Application No. 10-2015-0011455 filed on Jan. 23, 2015 in the Korean Intellectual Property Office, and all the benefits accruing therefrom under 35 U.S.C. 119, the contents of which in its entirety are herein incorporated by reference.

### BACKGROUND

1. Technical Field

The present disclosure generally relates to a system and method for file sharing, for example, a system and method for sending and receiving messages and managing versions of a sharing file by using an identifier of the sharing file.

2. Description of the Related Art

A service for sharing messages among users to send and receive instant messages has been known. However, since it generally focuses on messages, filing sharing is only regarded as an additional function. That is, it is convenient for sending and receiving messages in real time and simple file sharing, but it is inconvenient for sending and receiving messages associated with a specific file or managing versions of the file.

Meanwhile, a file sharing service in which files are uploaded and downloaded by authorized users has been known. However, since it generally focuses on files, it is necessary to use a separate channel in order to send and receive messages associated with a specific file. That is, it is necessary to separately inform about registration or change of files via email, an instant messenger or the like, and separately send and receive messages associated with a specific file, which may cause inconvenience.

In addition, there is a service such as Concurrent Versions System (CVS) or Subversion (SVN) specialized to manage the versions of a file between users. However, restrictions may be imposed on a file path or file name in order to manage the versions of a file. In other words, when files containing the same contents are stored in different file paths or with different file names depending on users, there is no function of recognizing these files as the same file and managing the versions of the file.

Therefore, in most cases, users insert the date or version information into the file name, and share the file via email, an instant messenger or the like. Then, messages associated with the file are sent and received via email, an instant messenger or the like. However, if the file is modified, the date or version information of the file name needs to be changed and inserted again before file sharing, which may cause inconvenience.

### SUMMARY

Some embodiments of the present disclosure may provide a file sharing system and method for sending and receiving messages associated with a sharing file.

Some embodiments of the present disclosure may also provide a file sharing system and method for managing a plurality of versions of a sharing file between users even when a file path or file name is different.

However, aspects of the present invention are not restricted to those set forth herein. The above and other aspects of the present invention will become more apparent to one of ordinary skill in the art to which the present invention pertains by referencing the detailed description of the present invention given below.

According to some embodiments of the present disclosure, messages can be sent and received in real time between users sharing a specific file by using an identifier of the sharing file. For example, since messages can be sent and received without having to change contents of the file, it may not exclude other users who share the file and send and receive messages via email, an instant messenger or the like as in a conventional method.

Further, in some exemplary embodiments, since various versions of the sharing file can be managed by using an identifier inserted into a metadata field of the sharing file, it is possible to manage the versions of the sharing file even when each user stores the sharing file in a different file path or with a different file name in the user's terminal as necessary.

In some embodiments, a file sharing system may comprise a server configured to receive and/or send one or more messages associated with a sharing file from and/or to one or more devices which store the sharing file and have authorization to access the messages associated with the sharing file.

In some embodiments, a file sharing system may comprise a server configured to store a sharing file having one or more versions and an identifier of the sharing file, receive the sharing file and the identifier of the sharing file from one or more devices, and determine a version of the received sharing file corresponding to the identifier of the sharing file by using a hash value of the sharing file and a time editing the sharing file.

In some embodiments, a file sharing method may comprise sending, by a server, one or more messages associated with a sharing file to one or more devices which store the sharing file and have authorization to access the messages associated with the sharing file.

In some embodiments, a file sharing method may comprise storing, by a server, a sharing file having one or more versions and an identifier of the sharing file, receiving, by the server, the sharing file and the identifier of the sharing file from one or more devices, and determining, by the server, a version of the received sharing file corresponding to the identifier by using a hash value of the sharing file and a time editing the sharing file.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram illustrating file sharing according to an embodiment of the present disclosure;

FIG. 2 is a flowchart illustrating a method for storing a user message received by a message management server to correspond to an identifier of the sharing file according to an exemplary embodiment of the present disclosure;

FIG. 3 is a diagram illustrating sending in real time messages received by the message management server to other user or terminal stored to correspond to the identifier of the sharing file according to an exemplary embodiment of the present disclosure;

FIG. 4 is a diagram illustrating that other terminal or the user of the other terminal storing the sharing file retrieves the messages stored to correspond to the identifier of the sharing file in the message management server according to an exemplary embodiment of the present disclosure;

FIG. 5 is a diagram illustrating steps of generating an identifier of the sharing file, generating an authorization key of the sharing file, and inserting the authorization key and the identifier into the sharing file in some embodiments of the present disclosure;

FIGS. 6A to 6C are diagrams illustrating that the authorization key and the identifier of the sharing file are inserted into the sharing file in some embodiments of the present disclosure;

FIG. 7 is a flowchart illustrating that the sharing file received by the message management server is stored to correspond to the identifier of the sharing file according to an exemplary embodiment of the present disclosure;

FIG. 8 is a diagram explaining that the sharing file received by the message management server is stored and a system message for registration of the sharing file is transmitted in real time to the other user stored to correspond to the identifier of the sharing file in an exemplary embodiment of the present disclosure;

FIG. 9 is a diagram explaining that the user of the other terminal storing the sharing file retrieves version information or data of the sharing file stored to correspond to the identifier of the sharing file in the message management server in an exemplary embodiment of the present disclosure;

FIG. 10 is a diagram illustrating that each terminal displays an image indicating the version of the sharing file to be superposed on or shown with the icon of the sharing file in an exemplary embodiment of the present disclosure;

FIG. 11 is a diagram explaining that a specific version of the sharing file stored to correspond to the identifier of the sharing file in the message management server is downloaded in an exemplary embodiment of the present disclosure;

FIG. 12 is a diagram illustrating that a user menu can be provided differently according to versions of the sharing file in an exemplary embodiment of the present disclosure;

FIG. 13 is a diagram illustrating a user interface for inputting and retrieving messages associated with the sharing file according to an exemplary embodiment of the present disclosure;

FIG. 14 shows a hardware configuration of the message management server used in an exemplary embodiment of the present disclosure; and

FIG. 15 is a conceptual diagram illustrating a file sharing system according to an exemplary embodiment of the present disclosure.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

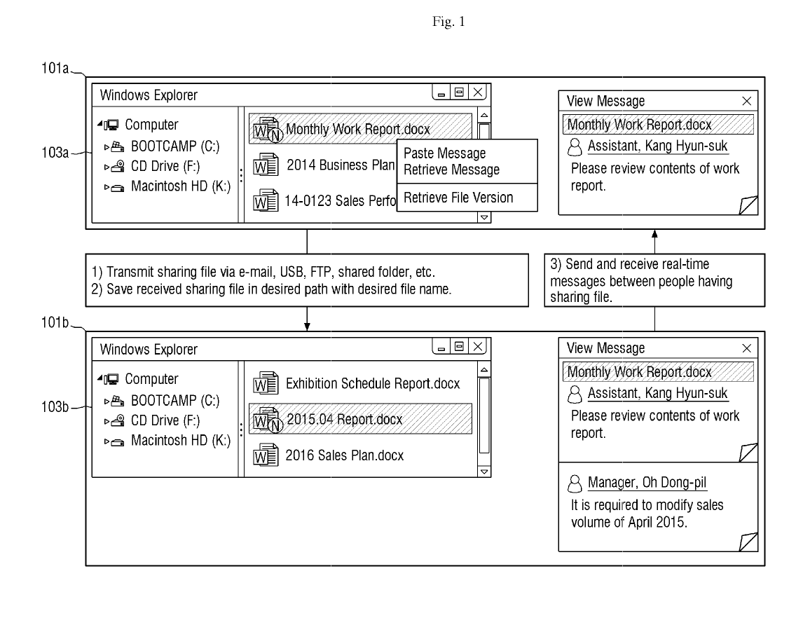

FIG. 1 is a diagram illustrating file sharing according to an embodiment of the present disclosure.

A user of a first terminal 101a may freely send a specific file owned by the user of the first terminal 101a to a user of a second terminal 101b via, for example, but not limited to, e-mail, USB, FTP, file sharing service or the like. Further, the user of the second terminal 101b having received a sharing file from the user of the first terminal 101a may store the file by changing a file path or file name as necessary.

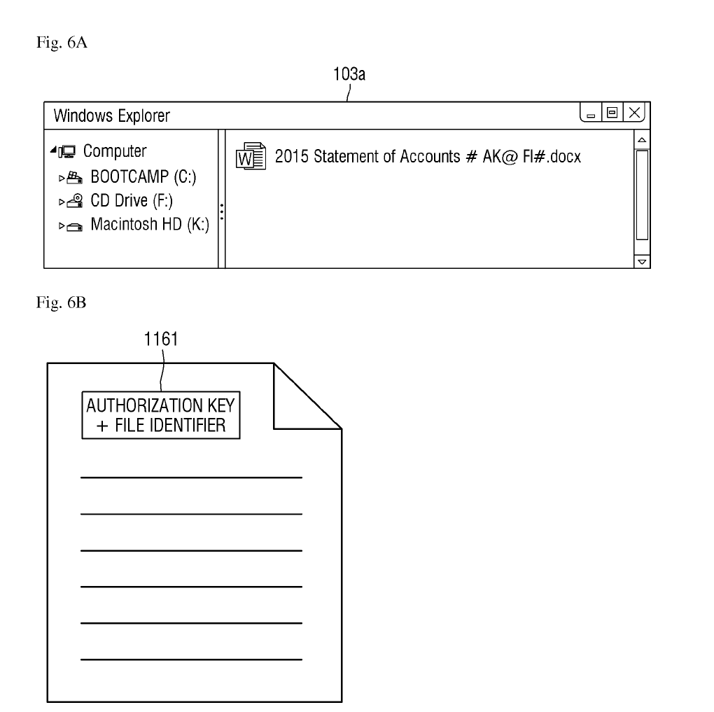

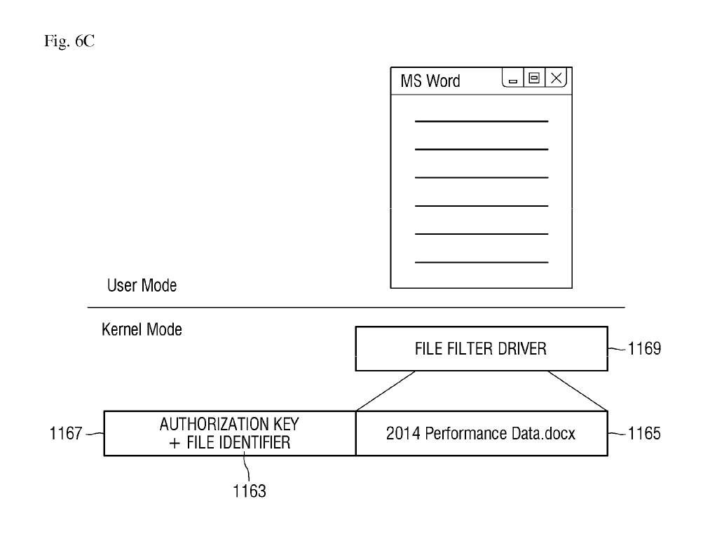

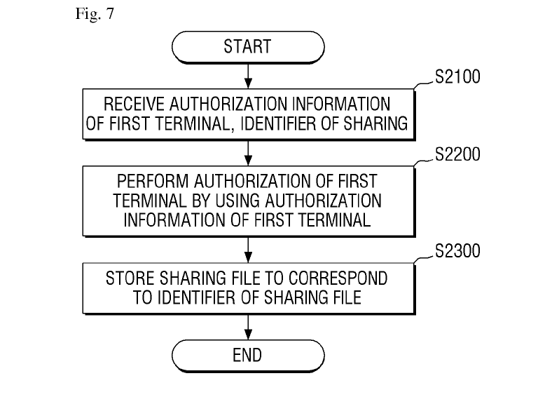

Referring to the embodiment shown in FIG. 1, the user of the first terminal 101a sends a file named “Monthly Work Report.docx” to the user of the second terminal 101b, and the user of the second terminal 101b saves the file as a different name “2015.04 Report.docx.” Even when two users save the file as different file names and/or in different paths, they may be recognized as the same file by using an identifier inserted into the sharing file. The identifier of the sharing file and a process of inserting the identifier into the sharing file will be described in detail later with reference to FIGS. 6A to 6C.

The users having the sharing file or terminals storing the sharing file may send and receive messages in real time between them through the medium of the sharing file into which an identifier is inserted. Although each terminal may have a separate user front-end to send and receive messages associated with the sharing file, it may be integrated with a file manager of the operating system of each terminal such that it can be used instinctively and easily. For example, a function of sending and receiving messages through a user menu associated with the sharing file may be provided in a file and/or folder management program such as “Explorer” of the Windows operating system or “Finder” of the Mac operating system

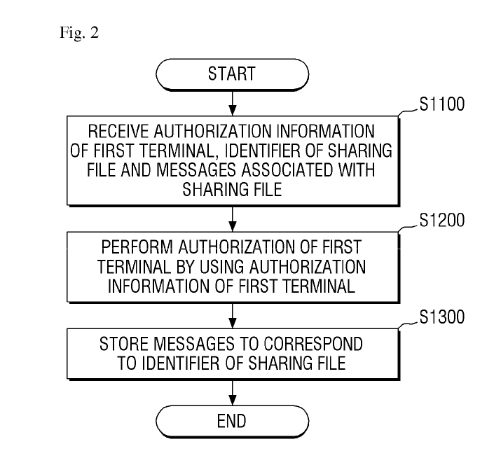

Referring to FIG. 1, the user of the first terminal 101a may select a sharing file in Windows Explorer 103a and activate a context menu through a mouse's right-click. When selecting Paste Message in the menu and inputting a message “Please review the contents of the work report” to be sent to the user of the second terminal 101b, the message is sent to the second terminal 101b or the user of the second terminal 101b having the sharing file. Similarly, when the user of the second terminal 101b selects a sharing file in Windows Explorer 103b, clicks Paste Message in the menu, and inputs a message “It is required to modify the sales volume of April 2015,” the message is sent to the first terminal 101a or the user of the first terminal 101a having the sharing file. Thus, the users having the sharing file may simply send and receive messages by using a file manager provided in the operating system, so that it is possible to more effectively communicate messages than sending and receiving messages associated with a file via a separate channel such as email or instant messaging. Sending and receiving messages in real time between users having a sharing file will be described in detail with reference to FIGS. 2 to 5.

Further, in some embodiments, by using the file manager provided by the operating system, it may be possible to easily manage versions of the sharing file. For instance, by managing versions of a sharing file by using an identifier inserted into the sharing file, a plurality of versions of the sharing file can be managed even when the user of each terminal saves the sharing file in a different file path or with a different file name. The management of versions of the sharing file into which an identifier is inserted will be described in detail later with reference to FIGS. 7 to 11.

FIG. 2 is a flowchart illustrating a method for storing a user message received by a message management server to correspond to an identifier of the sharing file according to an exemplary embodiment of the present disclosure.

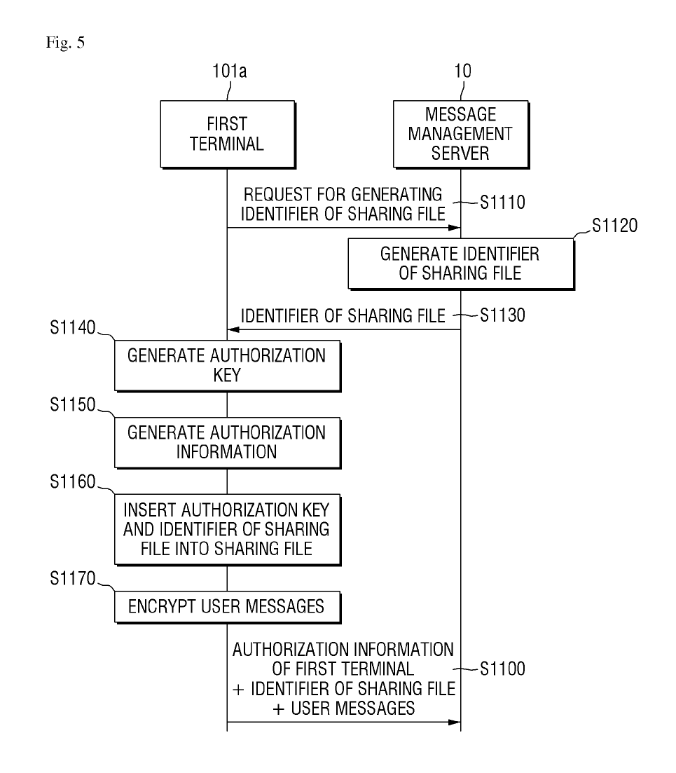

First, at least one of authorization information of the first terminal, an identifier of the sharing file, and messages associated with the sharing file may be received from the first terminal (S1100). The first terminal may be, for example, but not limited to, a terminal having a storage capable of storing the sharing file, such as a portable device, a personal computer (PC) and a smart phone, to send user messages associated with the sharing file to the message management server. The authorization information of the first terminal and the identifier of the sharing file will be described in detail later with reference to FIG. 5. The messages associated with the sharing file may be text messages which the user of the first terminal wants to send in association with the sharing file, but are not limited thereto. Generally, any form of information such as images, links and emoticons that can be sent and received via an instant messenger may be included in the messages. The message management server may receive at least one of the authorization information of the first terminal, the identifier of the sharing file, and the messages associated with the sharing file through telecommunication, mobile communication, wired/wireless network, or the like.

Next, authorization of the first terminal may be performed by using the authorization information of the first terminal (S1200). The authorization information of the first terminal may be generated by, for example, but not limited to, a hash function using an authorization key of the sharing file and/or an identifier of the sharing file as seed values. The message management server may check whether the messages have been received from an authorized terminal by using the authorization information of the first terminal.

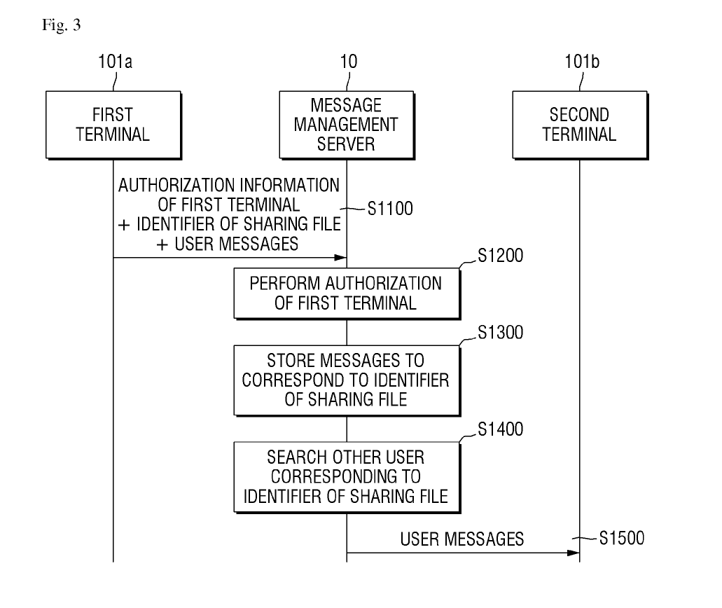

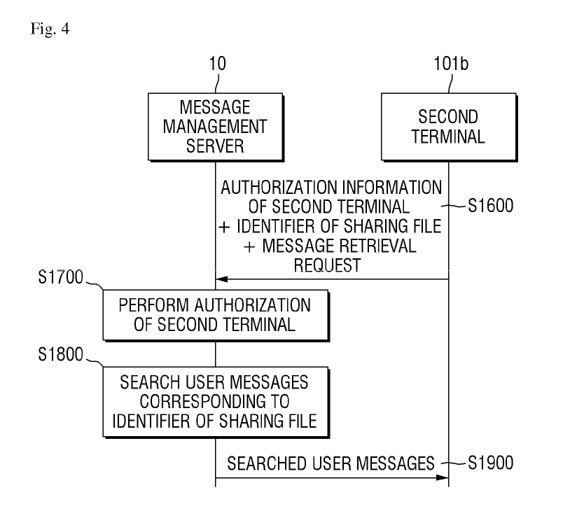

Next, when the authorization of the first terminal is successful, the messages may be stored to correspond to the identifier of the sharing file (S1300). In some embodiments, since the messages are stored to correspond to the identifier of the sharing file, the message management server may send the messages to other users. In addition, the users of other terminals storing the sharing file may retrieve the messages by using the identifier of the sharing file. This will be described in detail with reference to FIGS. 3 and 4.

FIG. 3 is a diagram illustrating sending in real time the messages received by the message management server to other user or terminal stored to correspond to the identifier of the sharing file according to an exemplary embodiment of the present disclosure.

A message management server 10 may store the messages received from the first terminal 101a to correspond to the identifier of the sharing file (S1300). Then, the message management server 10 may search other user or terminal stored to correspond to the identifier of the sharing file (S1400). The other user may be a user of the other terminal storing the same sharing file as the first terminal 101a, and a device identifier of the other user may be stored in advance in the message management server 10 to correspond to the identifier of the sharing file. Storing the device identifier of the other terminal to correspond to the identifier of the sharing file will be described in detail with reference to FIG. 4.

Next, the message management server 10 may send the messages to each terminal corresponding to the searched device identifier (S1500). Referring to FIG. 3, the second terminal 101b or the user of the second terminal 101b may be searched as the terminal or the user storing or having the same sharing file as the first terminal 101a. Accordingly, the message management server 10 may send the messages associated with the sharing file received from the first terminal 101a to the second terminal 101b. Thus, the messages may be sent and/or received in real time between users or terminals sharing the file by using the identifier of the sharing file.

FIG. 4 is a diagram illustrating that other terminal or the user of the other terminal storing the sharing file retrieves the messages stored to correspond to the identifier of the sharing file in the message management server according to an exemplary embodiment of the present disclosure.

The messages received from the first terminal 101a may be automatically sent to the other user storing the sharing file by the message management server 10 (S1500). However, in some cases, the device identifier of the terminal may not yet be stored in the message management server 10 storing the sharing file to correspond to the identifier of the sharing file. Alternatively, the terminal may individually retrieve the messages stored to correspond to the identifier of the sharing file. In preparation for this case, the message management server 10 may receive a message retrieval request, and send the messages stored to correspond to the identifier of the sharing file in response to the message retrieval request.

First, the authorization information of the second terminal 101b, the identifier of the sharing file and the message retrieval request may be received from the second terminal 101b which intends to retrieve the messages associated with the sharing file from the message management server 10 (S1600). Then, by using the authorization information of the second terminal 101b, the authorization of the second terminal 101b may be performed (S1700).

The authorization information of the second terminal 101b and a process of performing the authorization of the second terminal 101b may be the same as the authorization information of the first terminal 101a and the process of performing the authorization of the first terminal 101a, which have been described with reference to FIG. 2.

Next, when the authorization of the second terminal 101b is successful, the messages stored to correspond to the identifier of the sharing file can be searched (S1800). Then, in response to the message retrieval request, the searched messages may be sent to the second terminal 101b (S1900). Accordingly, it is possible to retrieve the messages sent and received previously as well as the messages sent and received in real time between users sharing the file.

According to an exemplary embodiment of the present disclosure, when the second terminal 101b activates the sharing file, the message retrieval request may be automatically sent to the message management server 10. Even though the user of the second terminal 101b does not separately send the message retrieval request to the message management server 10, it is possible to retrieve the messages stored to correspond to the identifier of the sharing file by simply executing the sharing file. Thus, when the first terminal 101a or the user of the first terminal 101a sends the messages, even if the second terminal 101b is unable to receive the messages in real time because of an offline mode or the like, the second terminal 101b may receive the messages later by automatically sending the message retrieval request with the execution of the sharing file. Further, the message retrieval request may be sent when the operating system of the second terminal 101b is started or when the second terminal 101b activates the sharing file.

According to an exemplary embodiment of the present disclosure, the step of sending the searched messages to the second terminal 101b (S1900) may include the step of storing the device identifier of the second terminal 101b to correspond to the identifier of the sharing file. If the device identifier of the terminal is not yet stored in the message management server 10 storing the sharing file to correspond to the identifier of the sharing file, the messages may be received in real time later through the message retrieval request.

FIG. 5 is a diagram illustrating steps of generating an identifier of the sharing file, generating an authorization key of the sharing file, and inserting the authorization key and the identifier into the sharing file in some embodiments of the present disclosure.

The transmission of the messages has been described with reference to FIGS. 2 and 3, and the message retrieval request has been described with reference to FIG. 4. From now on, there will be described a process of generating the authorization information of each terminal and the identifier of the sharing file commonly used in the transmission of the messages or the message retrieval request.

Since versions of the sharing file are managed and the messages are sent and received by using the identifier of the sharing file, the identifier of the sharing file may have a globally unique value in each terminal and the message management server 10. Thus, the identifier of the sharing file may be generated and allocated generally by the message management server 10. For example, a request for generating an identifier of the sharing file may be received from the first terminal 101a which intends to initially send the messages associated with the sharing file to the message management server 10 (S1110), a globally unique identifier of the sharing file may be generated by the message management server 10 (S1120), and the generated identifier of the sharing file may be transmitted to the first terminal 101a (S1130). The step of generating the identifier of the sharing file may be performed initially one time. Thereafter, it is possible to send and receive the messages or send the message retrieval request by using the generated identifier of the sharing file. However, if the globally unique characteristics of the identifier of the sharing file can be secured, a process of generating the identifier of the sharing file may be performed in each terminal. For example, the identifier of the sharing file may be generated by combining a linear counter value managed in each terminal and the device identifier of each terminal.

Further, the first terminal 101a which intends to initially transmit the messages associated with the sharing file to the message management server 10 may generate an authorization key of the sharing file (S1140). The first terminal 101a may generate the authorization information by, for example, but not limited to, a hash function using the authorization key and the identifier of the sharing file as seed values (S1150). In this case, algorithms capable of mapping variable-length data, i.e., seeds, to fixed-length data are collectively referred to as a hash function. The calculation result of the hash function is called a hash value, hash code, hash sum, checksum, hash or the like, as the mapped fixed-length data. The hash function is a one-way function which is difficult to calculate seeds again from the results derived from the seeds.

The message management server 10 may perform authorization on each terminal by using the authorization information generated by the hash function using the authorization key and the identifier of the sharing file as seed values, and send the messages or the message retrieval request. In some embodiments, the authorization information and the identifier of the sharing file may be essential parameters for all or some transactions that occur through the medium of the sharing file. Thus, the user of each terminal storing the sharing file may have the authorization information and the identifier of the sharing file. Of course, the authorization information and the identifier of the sharing file may be transmitted separately from the transmission of the sharing file. However, it is more preferable in terms of convenience that the authorization information and the identifier of the sharing file are transmitted together with the sharing file. Further, it is more preferable in terms of security that the authorization key capable of generating the authorization information is transmitted together with the sharing file rather than directly sending the authorization information.

The first terminal 101a which intends to initially send the messages associated with the sharing file to the message management server 10 may perform the step of inserting the authorization key and the identifier of the sharing file into the sharing file (S1160). The insertion of the identifier into the sharing file will be described in detail with reference to FIGS. 6A to 6C.

According to an exemplary embodiment of the present disclosure, the first terminal 101a may encrypt the messages by using the authorization key of the sharing file (51170), and send the encrypted messages to the message management server 10 (S1100). When the messages are encrypted by using the authorization key inserted into the sharing file in the first terminal 101a for sending the messages and transmitted to the message management server 10, the encrypted messages are stored in the message management server 10. The second terminal 101b which has received the encrypted messages from the message management server 10 may decode the messages by extracting the authorization key inserted into the sharing file. Thus, in some embodiments, the encrypted messages may be stored in the message management server 10 to enhance the security, and each terminal having the sharing file may encrypt and decode the messages by using the authorization key inserted into the sharing file.

FIGS. 6A to 6C are diagrams illustrating that the authorization key and the identifier of the sharing file are inserted into the sharing file in some embodiments of the present disclosure.

For example, the first terminal 101a may change the file name of the sharing file to include the authorization key and the identifier of the sharing file (S1160). Referring to FIG. 6A, the sharing file having an original file name “2015 Statement of Accounts.docx” may be changed to the sharing file having a file name “2015 Statement of Accounts # AK(Authorization Key) @ FI(File Identifier) #.docx.” The authorization key and the file identifier may be extracted by using “#” and “@” as separators.

Alternatively, the authorization key and the identifier of the sharing file may be inserted into a metadata field of the sharing file (S1160). For example, document file formats such as PPT, DOC and XLS, image file formats such as JPEG and TIFF and music file formats such as MP3 and MP4 have metadata fields called attributes, EXIF, ID3 and the like to write or store various additional information. By inserting or storing the authorization key and the file identifier into or in the metadata field, the authorization key and the file identifier may not exposed directly to the user compared to the insertion into the file name. As shown in the exemplary embodiment of FIG. 6B, the authorization key and the identifier of the sharing file may be inserted into a metadata field 1161 of the file.

In another exemplary embodiment, the authorization key and the identifier of the sharing file may be inserted into a header or footer to be combined with an original sharing file (S1160). That is, a file with a new format may be created by combining a header or footer with the sharing file. By creating a file with a new format by combining a header or footer including the authorization key and the file identifier with the original sharing file, it is possible to enhance the security compared to the insertion of the authorization key and the identifier into the metadata field. It may be impossible to check a file with a new format in an application connected to the original sharing file. However, by installing a file system filter driver provided by the operating system, the application connected to the original sharing file may be configured to access the original sharing file obtained by excluding the header and footer from the file with a new format.

In the example of FIG. 6C, the authorization key and a file identifier 1163 of the sharing file may be inserted into a header 1167 of the file with a new format, and the original sharing file may be inserted into a body 1165 of the file with the new format. The user may access the file with the new format by using the application connected to the original sharing file through a file filter driver 1169 of the operating system.

When the sharing file into which the authorization key and the identifier of the sharing file are inserted is delivered to other user or terminal, the other user or terminal having received the sharing file does not need to generate an authorization key repeatedly or make a request for generating the file identifier. Instead, it may be possible to send and receive the messages associated with the sharing file, or make a message retrieval request by extracting the authorization key and the identifier inserted into the sharing file.

In particular, a method of inserting the authorization key and the identifier into the file name of the sharing file or the metadata field of the sharing file may not change the contents of the sharing file. That is, the method of the insertion of the authorization key or the identifier without having to change the contents of the file may not exclude other users who share the file and send and receive messages via email, an instant messenger or the like as in a conventional method. Further, a method of inserting the authorization key and the identifier into the metadata field of the sharing file or a header or footer of the file with a new format may enhance the security in that the authorization key and the identifier are not exposed to the user.

FIG. 7 is a flowchart illustrating that the sharing file received by the message management server is stored to correspond to the identifier of the sharing file according to an exemplary embodiment of the present disclosure.

First, at least one of the authorization information of the first terminal, the identifier of the sharing file, and the sharing file may be received from the first terminal which intends to register the sharing file in the message management server (S2100). Then, the authorization of the first terminal may be performed by using the authorization information of the first terminal (S2200). Then, when the authorization of the first terminal is successful, the sharing file may be stored to correspond to the identifier of the sharing file (S2300).

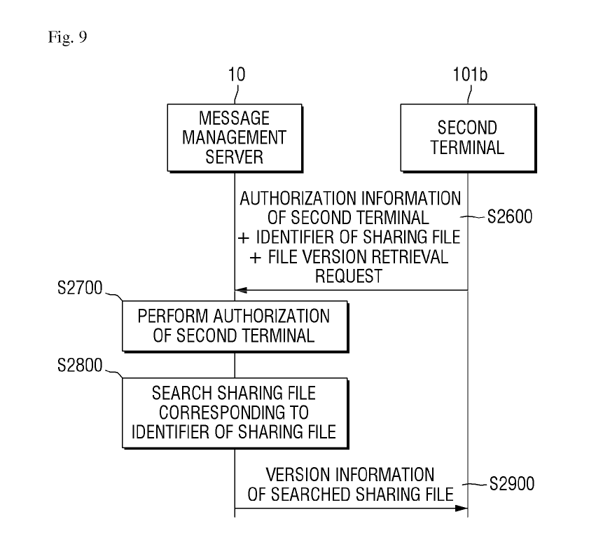

In this case, the authorization information of the first terminal or the identifier of the sharing file may be the same as or similar with those described with reference to FIGS. 2 to 5. By storing the sharing file in the message management server 10 by matching the sharing file to the identifier of the sharing file, the versions of the sharing file can be managed by using the file identifier. This will be described in detail with reference to FIG. 9.

Further, since the identifier of the sharing file may be inserted into the file name or the metadata field of the sharing file, the authorization information of the first terminal and the sharing file may be received instead of receiving the authorization information of the first terminal, the identifier of the sharing file, and the sharing file. The file identifier may be extracted from the sharing file and the sharing file may be stored to correspond to the extracted file identifier.

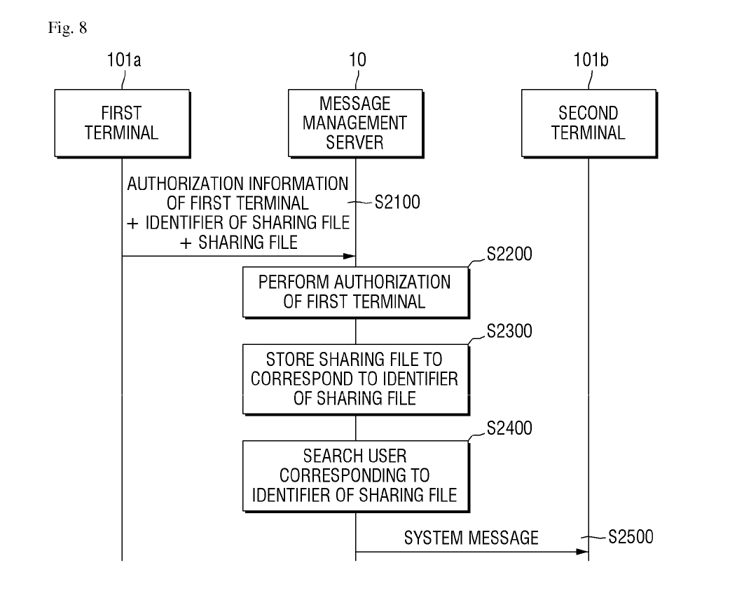

FIG. 8 is a diagram explaining that the sharing file received by the message management server is stored and a system message for registration of the sharing file is transmitted in real time to the other user stored to correspond to the identifier of the sharing file according to an exemplary embodiment of the present disclosure.

The transmission of the user messages in real time to each terminal or the user of each terminal storing the sharing file by using the identifier of the sharing file has been described with reference to FIG. 3. Similarly, the message management server 10 may transmit not only user messages but also a system message to each user or terminal stored to correspond to the identifier of the sharing file.

The message management server 10 may store the sharing file received from the first terminal 101a to correspond to the identifier of the sharing file (S2300), and may search other terminal or user stored to correspond to the identifier of the sharing file (S2400). Next, the message management server 10 may send a system message to each terminal corresponding to the searched device identifier (S2500). In this case, the system message may be a message generated by the message management server 10 with respect to the registration of the sharing file. For example, the system message such as “a user OOO has registered a sharing file OOO at XX:XX:XX on XX/XX in 2015” may be automatically generated and transmitted to terminals or the user of each terminal storing the sharing file. Thus, the information regarding the update of the sharing file may be easily guided or provided to the user of each terminal storing the sharing file.

The message management server 10 may not only simply store the received sharing file, but also manage a plurality of versions of the sharing file based on, for example, but not limited to, a hash value of the sharing file and a time editing the sharing file. For instance, if the message management server 10 receives the sharing file, it may be determined that the file is a new file or previously stored file by comparing the hash value of the received sharing file and the time editing the sharing file with the hash value of the previously stored sharing file and the time editing the sharing file. If the received sharing file is a new file, the version of the received sharing file may be determined, and the received sharing file may be stored in the message management server 10. Thus, various versions of sharing files, each stored to correspond to the identifier of the sharing file, may be retrieved for each version.

Further, information of the determined version of the sharing file may be inserted into the received sharing file, and the sharing file into which the version is inserted may be stored in the message management server 10. In this case, the version of the sharing file may be generated by, for instance, but not limited to, using a counter value that increases linearly for each sharing file, and the version of the sharing file may be inserted into the metadata field of the sharing file. When the version is inserted into the sharing file and stored in the message management server 10, the load on the server may be reduced when a difference between the version of the sharing file stored in the terminal and the latest version of the sharing file stored in the server is displayed as a number on an icon in an exemplary embodiment of the present disclosure to be described below.

FIG. 9 is a diagram explaining that the user of the other terminal storing the sharing file retrieves version information or data of the sharing file stored to correspond to the identifier of the sharing file in the message management server in an exemplary embodiment of the present disclosure.

First, at least one of the authorization information of the second terminal 101b, the identifier of the sharing file, and a file version retrieval request may be received from the second terminal 101b which intends to retrieve the version of the sharing file (S2600). Next, the authorization of the second terminal 101b may be performed by using the authorization information of the second terminal 101b (S2700). Then, when the authorization of the second terminal 101b is successful, the sharing file stored to correspond to the identifier of the sharing file may be searched (S2800). Next, in response to the file version retrieval request, the version of the searched sharing file may be transmitted to the second terminal 101b (S2900). Through the file version retrieval request, it is possible to check whether the sharing file owned by the second terminal 101b has the latest version, or the sharing file is updated in the message management server 10 after that.

According to an exemplary embodiment of the present disclosure, when the second terminal 101b activates the sharing file, the file version retrieval request may be automatically sent to the message management server 10. Although the user of the second terminal 101b does not separately send the file version retrieval request to the message management server 10, it is possible to retrieve the version of the sharing file stored to correspond to the identifier of the sharing file by simply executing the sharing file. Further, the file version retrieval request may be sent when the operating system of the second terminal 101b is started instead of when the second terminal 101b activates the sharing file.

According to another exemplary embodiment of the present disclosure, the second terminal 101b may determine the version of the sharing file owned by the second terminal 101b by using the version of the sharing file received from the message management server 10. Further, the version information or data of the sharing file may be inserted into its own sharing file. In addition, the version of its own sharing file may be displayed visually with an icon or the like.

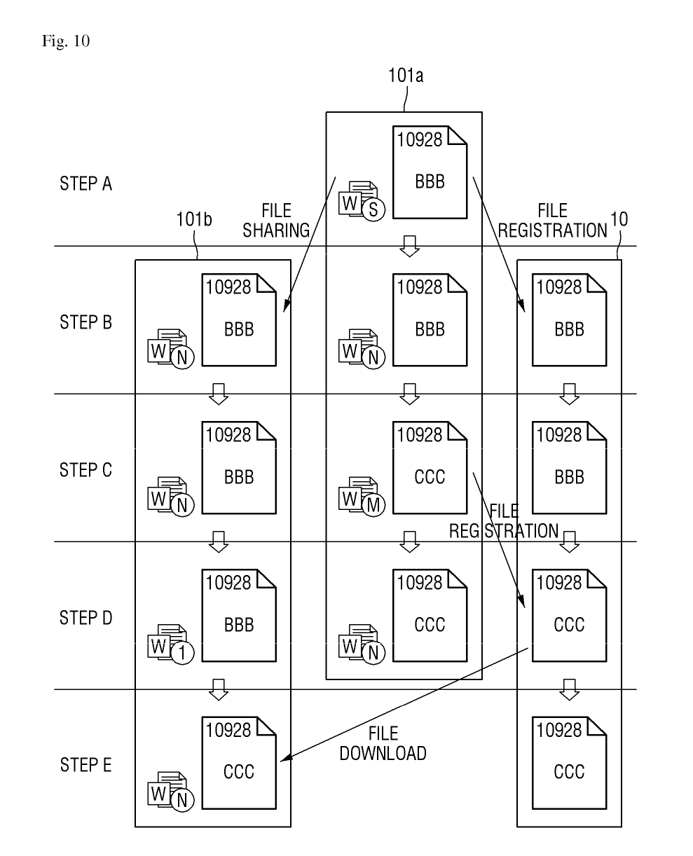

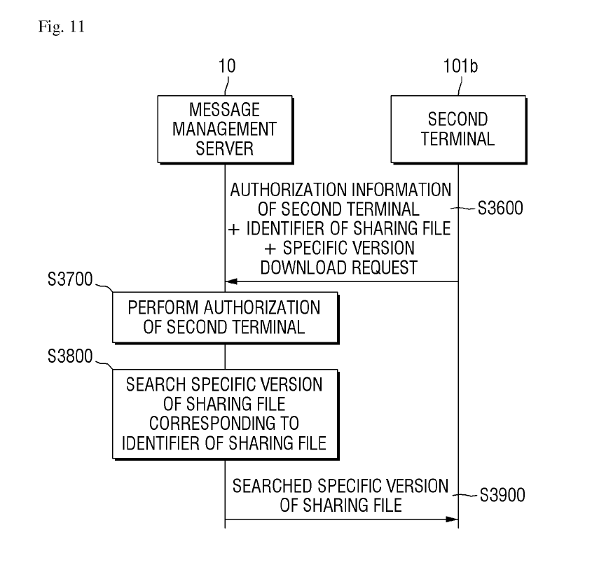

FIG. 10 is a diagram illustrating that each terminal displays an image indicating the version of the sharing file to be superposed on or shown with the icon of the sharing file in an exemplary embodiment of the present disclosure.

For example, if the sharing file owned by or stored in the terminal is not yet stored in the message management server 10 to manage the versions, S (save) may be represented on the icon of the sharing file. Alternatively, if the sharing file owned by or stored in the terminal is the same as the sharing file stored in the message management server 10, N (new) may be represented on the icon. If the sharing file owned by or stored in the terminal has a version older than the sharing file stored in the message management server 10, a version difference may be represented as a number on the icon. If the sharing file owned by or stored in the terminal has a version newer than the sharing file stored in the message management server 10, i.e., if the sharing file has been modified, but is not yet stored in the message management server 10, M (modify) may be represented on the icon.

Referring to FIG. 10, in step A, a user of the first terminal 101a may generate a sharing file having an identifier “10928” and contents “BBB.” Since the shared file is not yet stored in the message management server 10, “S” may be displayed on the icon of the sharing file. Then, in step B, when the user of the first terminal 101a sends the sharing file to a user of the second terminal 101b and registers the sharing file in the message management server 10, since both the first terminal 101a and the second terminal 101b have the latest version of the file, “N” may be displayed on the icon of the sharing file. Then, in step C, when the user of the first terminal 101a changes the contents of the sharing file to “CCC,” since the first terminal 101a has a modified file, “M” may be displayed on the icon. Then, in step D, when the user of the first terminal 101a registers the sharing file in the message management server 10, “N” may be displayed on the icon of the sharing file in the first terminal 101a because the first terminal 101a has the latest version of the file, and “1” indicating a version difference may displayed on the icon of the sharing file in the second terminal 101b because the second terminal 101b has an older version of the file. Finally, in step E, when the user of the second terminal 101b downloads the latest version of the file from the message management server 10, “N” may be displayed on the icon of the sharing file in the second terminal 101b.

As illustrated in FIG. 10, the user of the first terminal 101a may send the sharing file of “10928” initially one time to the user of the second terminal 101b. Then, even in the case that the contents of the file are changed, there may be no need to send the file again to the second terminal 101b or the user of the second terminal 101b. Instead of sending the changed file again by the user of the first terminal 101a, the user of the second terminal 101b may personally download the latest version of the file from the message management server 10. Thus, the file version can be managed easily and the latest version of the file can be shared.

FIG. 11 is a diagram explaining that a specific version of the sharing file stored to correspond to the identifier of the sharing file in the message management server is downloaded in an exemplary embodiment of the present disclosure.

As described above, when the version of the sharing file is managed via the message management server 10, it may be supported to enable a backup using the version information, or update to the latest sharing file.

First, at least one of the authorization information of the second terminal 101b, the identifier of the sharing file and a specific version download request may be received from the second terminal 101b which intends to download a specific version of the sharing file from the message management server 10 (S3600). Then, the authorization of the second terminal 101b may be performed by using the authorization information of the second terminal 101b (S3700). Then, when the authorization of the second terminal 101b is successful, a specific version of the sharing file stored to correspond to the identifier of the sharing file may be searched (S3800). Then, in response to the specific version download request, a specific version of the searched sharing file may be transmitted to the second terminal 101b (S3900).

By managing versions of the sharing file by using the identifier of the sharing file, even though each user sharing the file can store the file in a different file path or with a different file name as necessary, it is possible to manage and update the versions of the file.

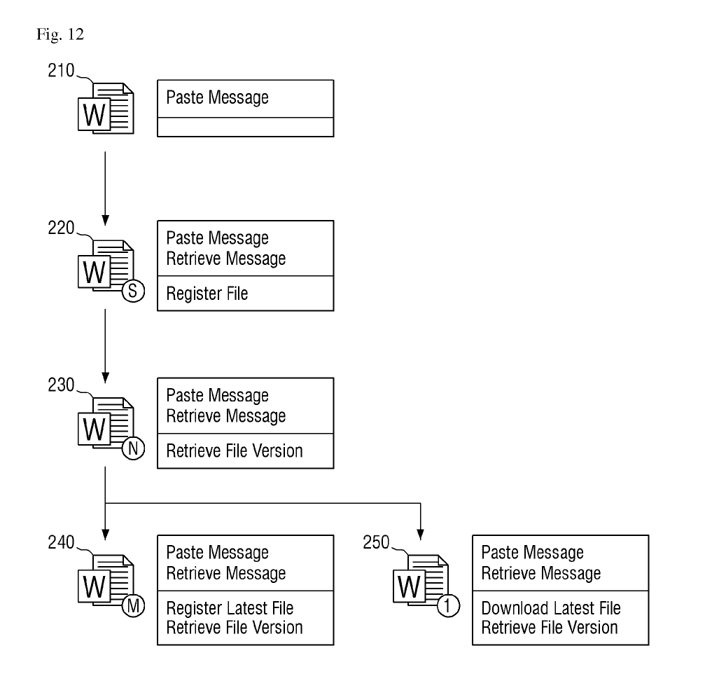

FIG. 12 is a diagram illustrating that a user menu is provided differently according to versions of the sharing file in an exemplary embodiment of the present disclosure.

The above-described functions such as the transmission of the user messages, the message retrieval request, the registration of the sharing file, the file version retrieval request, and the specific version download request may have a separate user front end, but they may be integrated with a file manager of the operating system of each terminal such that they can be used instinctively, intuitively and easily.

For example, the user of the first terminal 101a may search a sharing file storage path by executing a file and/or folder management program such as the Explorer in the operating system of the first terminal 101a storing the sharing file. The Explorer may display an icon indicating the sharing file in the path, and provide various functions associated with the sharing file through a context menu that is provided when the icon is right-clicked.

A case of sending a user message will be described as an example. When selecting “Paste Message” in the context menu provided by a mouse's right-click on the icon, a separate user interface for inputting a message may be provided. The separate user interface for inputting a message may be similar to a message input window of a general instant messenger. The first terminal 101a may receive contents of the message via the user interface, and send the received contents of the message to the message management server 10. The message management server 10 may send the contents of the message received by each terminal storing the sharing file.

Referring to FIG. 12, the functions offered may vary depending on the versions of the sharing file. Hereinafter, the menu will be described in brackets [ ]. If it is a general file in which an identifier of the sharing file has not been generated (210), a menu item [Paste Message] may be provided. Alternatively, a menu item [Create File Identifier] may be provided. Then, if the version of the sharing file into which the identifier has been inserted has not been managed (220), one or more menu items [Paste Message], [Retrieve Message] and [Register File] may be provided together with an icon marked with “S.” If the sharing file has been registered in the message management server 10 (230), since it is the latest version of the file, one or more menu items [Paste Message], [Retrieve Message] and [Retrieve File Version] may be provided together with the icon marked with “N.” If the file has been modified (240), one or more menu items [Paste Message], [Retrieve Message], [Register Latest File] and [Retrieve File Version] may be provided together with the icon marked with “M.” If the user of the other terminal has updated the sharing file (250), one or more menu items [Paste Message], [Retrieve Message], [Download Latest File] and [Retrieve File Version] may be provided together with the icon marked with a number such as “1” indicating a version difference of the sharing file. Thus, by providing the propagation of the messages associated with the sharing file and the management of the versions in combination with the file manager of the operating system, the users can share the file and easily input information as if a post-it note is attached to the file using the file manager of the operating system as a message board.

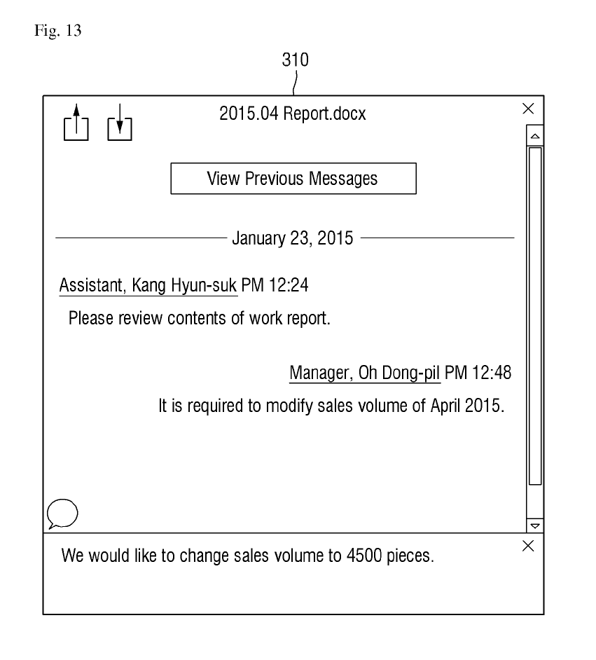

FIG. 13 is a diagram illustrating a user interface for inputting and retrieving messages associated with the sharing file according to an exemplary embodiment of the present disclosure.

According to an exemplary embodiment of the present disclosure, a user interface 310 for inputting and retrieving messages associated with the sharing file may be similar to a user interface for inputting messages of an instant messenger. At the top of the user interface, information about the file, such as the date/time and a person creating the file, the last date/time and a person registering the file, the file size, and brief description of the file, may be provided. Further, file upload and download functions may be provided as buttons. At the middle of the user interface, messages sent and received between users having the sharing file may be provided. At the bottom of the user interface, an input window through which the user message can be inputted may be provided.

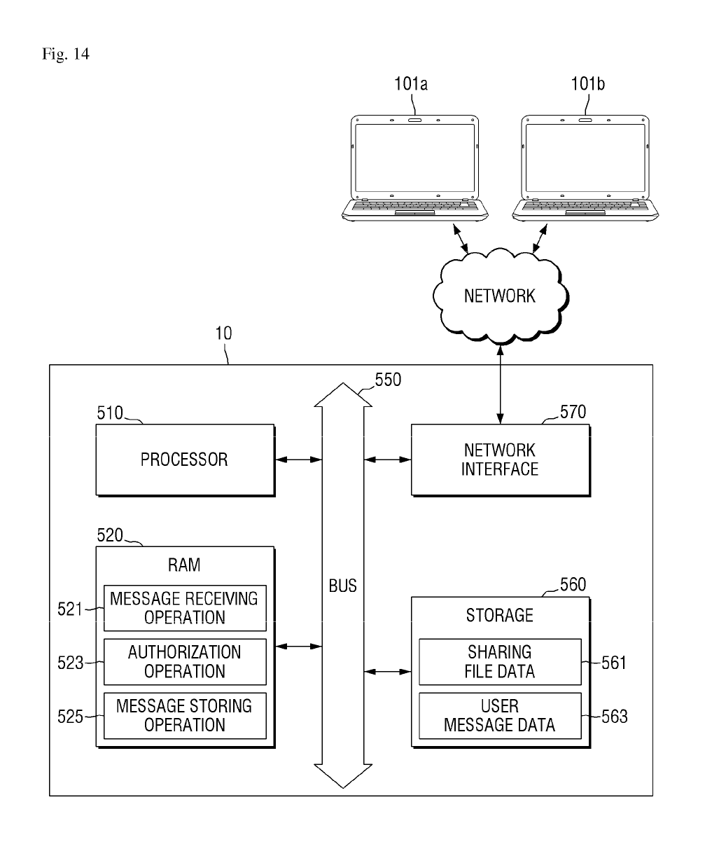

FIG. 14 shows a hardware configuration of the message management server used in an exemplary embodiment of the present disclosure.

Referring to FIG. 14, the message management server 10 may include at least one processor 510, a memory 520, a storage 560, and a network interface 570. The processor 510, the memory 520, the storage 560 and the interface 570 may send and receive data through a system bus 550.

The processor 510 may executes a computer program loaded in the memory 520, and the memory 520 loads the computer program from the storage 560. The computer program may include a message receiving operation 521, an authorization operation 523 and a message storing operation 525.

The message receiving operation 521 may receive at least one of the authorization information of the first terminal 101a, the identifier of the sharing file and the messages associated with the sharing file through the network interface 570, and load them in the memory 520. The authorization operation 523 may perform authorization of the first terminal 101a by using the authorization information of the first terminal 101a and generate an authorization result. The message storing operation 525 may store the messages to correspond to the identifier of the sharing file when the authorization result generated by the authorization operation 523 is successful. The matching data may be stored as sharing file data 561 and user message data 563 of the storage 560, respectively, through the system bus 550.

The message management server 10 may provide an interface for retrieving the sharing file data 561 and the user message data 563 through the network interface 570.

The elements of the apparatus 10 may be implemented as software or as hardware such as field-programmable gate arrays (FPGAs) or application-specific integrated circuits (ASICs), but the invention is not limited thereto. That is, the elements of the apparatus 10 may be configured to reside in an addressable storage medium or to execute one or more processors. Each of the elements of the apparatus 10 may be divided into one or more sub-elements such that the functions of the corresponding element can be distributed between the sub-elements, or the elements of the apparatus 10 and the functions thereof may be incorporated into fewer elements.

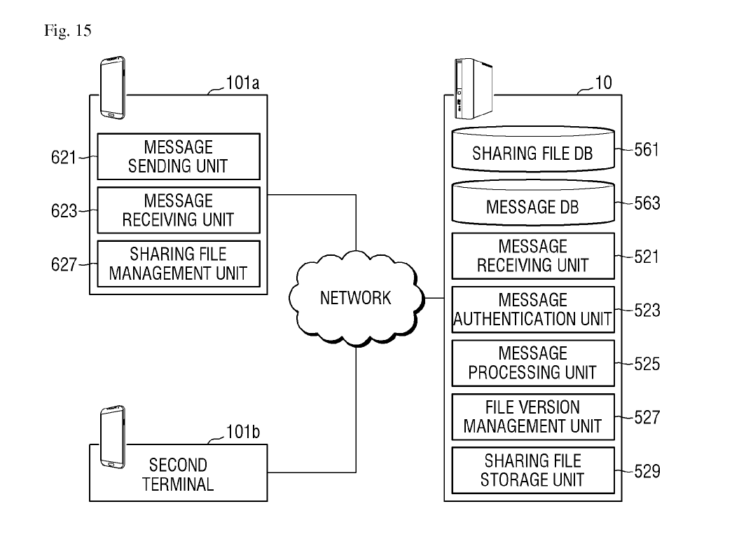

FIG. 15 is a conceptual diagram illustrating a file sharing system according to an exemplary embodiment of the present disclosure.

Referring to FIG. 15, the file sharing system may include the message management server 10, the first terminal 101a and the second terminal 101b.

The message management server 10 may include a sharing file database 561 for storing a sharing file and a message database 563 for storing messages. Further, the message management server 10 may include a message receiving unit 521 receiving messages associated with the sharing file from each terminal, a message authentication unit 523 authenticating whether the received messages are sent from a legitimate user, and a message processing unit 525 transmitting the received messages to other user having the sharing file when the authorization is successful. Further, the message management server 10 may include a file version management unit 527 managing versions of the sharing file received from each terminal and a sharing file storage unit 529 storing the sharing file for each version in the sharing file database 561.

Each terminal may include a message sending unit 621 sending messages received from the user to the message management server 10, a message receiving unit 623 receiving the messages sent by the user of the other terminal from the message management server 10, and a sharing file management unit 627 downloading the latest version of the file from the message management server 10 or uploading the modified file.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A file sharing system, comprising:
a server configured to receive and/or send one or more messages associated with a sharing file from and/or to one or more devices which store the sharing file and have authorization to access the messages associated with the sharing file.

2. The system of claim 1, wherein the server is configured to receive authorization information and an identifier of the sharing file from the one or more devices.

3. The system of claim 2, wherein the server is configured to check whether the one or more devices have the authorization to access the messages associated with the sharing file by using the authorization information and the identifier of the sharing file.

4. The system of claim 2, wherein the authorization information is generated from an authorization key and the identifier of the sharing file by a hash function.

5. The system of claim 1, wherein the server is configured to store the received messages to correspond to an identifier of the sharing file.

6. The system of claim 5, wherein the server is configured to send the stored messages corresponding to the identifier of the sharing file to the one or more devices.

7. The system of claim 1, wherein the server is configured to store a device identifier of each of the one or more devices to correspond to an identifier of the sharing file.

8. The system of claim 7, wherein the server is configured to send the messages to the one or more devices of which device identifier is stored to correspond to the identifier of the sharing file.

9. The system of claim 5, wherein the server is configured to send the messages, stored to correspond to the identifier of the sharing file, to the one or more devices in response to a request for searching the messages associated with the sharing file.

10. The system of claim 9, further comprising the one or more devices configured to generate the request for searching the messages associated with the sharing file.

11. The system of claim 10, wherein the one or more devices are configured to generate the request for searching the messages in response to execution of the sharing file.

12. The system of claim 1, wherein the server is configured to generate an identifier of the sharing file in response to a request signal from the one or more devices.

13. The system of claim 2, wherein a file name of the sharing file comprises the authorization information and the identifier of the sharing file.

14. The system of claim 13, wherein one or more predefined characters are included in the file name of the sharing file to distinguish between the authorization information (and/or the identifier of the sharing file) and other portions of the file name and/or between the authorization information and the identifier of the sharing file.

15. The system of claim 2, wherein the authorization information and the identifier of the sharing file are included in a meta data field of the sharing file.

16. The system of claim 2, wherein the authorization information and the identifier of the sharing file are comprised in a header or a footer of a file with a new format, and the sharing file is comprised in a body of the file with the new format.

17. The system of claim 4, wherein:
the server and/or the one or more devices are configured to encrypt the messages associated with the sharing file, and
the one or more devices are configured to decode the encrypted messages by using the authorization key.

18. The system of claim 1, wherein the server is configured to send a system message to the one or more devices.

19. The system of claim 1, further comprising the one or more devices configured to output or display the messages associated with the sharing file.

20. The system of claim 19, wherein the one or more devices are configured to output or display the messages associated with the sharing file in response to execution of the sharing file.

21. The system of claim 1, wherein the server is configured to manage versions of the sharing file by using a hash value of the sharing file and a time editing the sharing file.

22. A file sharing system, comprising a server configured to:
store a sharing file having one or more versions and an identifier of the sharing file;
receive the sharing file and the identifier of the sharing file from one or more devices; and
determine a version of the received sharing file corresponding to the identifier of the sharing file by using a hash value of the sharing file and a time editing the sharing file.

23. The system of claim 22, wherein the server is configured to send information of the determined version of the received sharing file to the one or more devices.

24. The system of claim 22, wherein the server is configured to assign new version to the received sharing file when the received sharing file corresponding to the identifier of the sharing file is not stored in the server.

25. The system of claim 22, wherein the one or more devices have authorization to access the messages associated with the sharing file.

26. The system of claim 22, wherein the server is configured to provide a history of the versions of the sharing file corresponding to the identifier.

27. The system of claim 22, wherein the server is configured to send the sharing file with a version requested by the one or more devices.

28. The system of claim 23, further comprising the one or more devices configured to send a request for the information of the version of the sharing file in response to execution of the sharing file.

29. The system of claim 22, further comprising the one or more devices configured to output or display the version of the sharing file with an icon of the sharing file.

30. A file sharing method, comprising:
sending, by a server, one or more messages associated with a sharing file to one or more devices which store the sharing file and have authorization to access the messages associated with the sharing file.

31. The method of claim 30, further comprising receiving, by the server, the one or more messages associated with the sharing file from the one or more devices.

32. The method of claim 31, further comprising receiving, by the server, authorization information and an identifier of the sharing file from the one or more devices.

33. The method of claim 32, further comprising checking, by the server, whether the one or more devices have the authorization to access the messages associated with the sharing file by using the authorization information and the identifier of the sharing file.

34. The method of claim 32, further comprising, generating, by the server or by the one or more devices, the authorization information from an authorization key and the identifier of the sharing file by using a hash function.

35. The method of claim 31, further comprising, by the server, storing the received messages to correspond to an identifier of the sharing file.

36. The method of claim 35, further comprising sending, by the server, the stored messages corresponding to the identifier of the sharing file to the one or more devices.

37. The method of claim 30, further comprising storing, by the server, a device identifier of each of the one or more devices to correspond to an identifier of the sharing file.

38. The method of claim 37, further comprising sending, by the server, the messages to the one or more devices of which device identifier is stored to correspond to the identifier of the sharing file.

39. The method of claim 35, further comprising sending, by the server, the messages, stored to correspond to the identifier of the sharing file, to the one or more devices in response to a request for searching the messages associated with the sharing file.

40. The method of claim 39, further comprising generating, by the one or more devices, the request for searching the messages associated with the sharing file.

41. The method of claim 40, wherein the one or more devices generate the request for searching the messages in response to execution of the sharing file.

42. The method of claim 30, further comprising generating, by a server, an identifier of the sharing file in response to a request signal from the one or more devices.

43. The method of claim 32, further comprising generating or modifying a file name of the sharing file to include the authorization information and the identifier of the sharing file in the file name of the sharing file.

44. The method of claim 43, further comprising adding one or more predefined characters between the authorization information (and/or the identifier of the sharing file) and other portions of the file name and/or between the authorization information and the identifier of the sharing file.

45. The method of claim 32, further comprising inserting the authorization information and the identifier of the sharing file to a meta data field of the sharing file.

46. The method of claim 32, further comprising generating a file with a new format comprising the authorization information and the identifier of the sharing file as a header or a footer and the sharing file as a body.

47. The method of claim 34, further comprising:
encrypting, by the server and/or the one or more devices, the messages associated with the sharing file; and
decoding, by the one or more devices, the encrypted messages by using the authorization key.

48. The method of claim 30, further comprising sending, by the server, a system message to the one or more devices.

49. The method of claim 30, further comprising outputting or displaying, by the one or more devices, the messages associated with the sharing file sent from the server.

50. The method of claim 49, wherein the one or more devices output or display the messages associated with the sharing file in response to execution of the sharing file.

51. The method of claim 30, further comprising managing, by the server, versions of the sharing file by using a hash value of the sharing file and a time editing the sharing file.

52. A file sharing method, comprising:
storing, by a server, a sharing file having one or more versions and an identifier of the sharing file;
receiving, by the server, the sharing file and the identifier of the sharing file from one or more devices; and
determining, by the server, a version of the received sharing file corresponding to the identifier by using a hash value of the sharing file and a time editing the sharing file.

53. The method of claim 52, further comprising sending, by the server, information of the determined version of the received sharing file to the one or more devices.

54. The method of claim 52, further comprising assigning, by the server, new version to the received sharing file when the received sharing file corresponding to the identifier of the sharing file is not stored in the server.

55. The method of claim 52, further comprising checking, by the server, whether the one or more devices have authorization to access the messages associated with the sharing file.

56. The method of claim 52, further comprising providing, by the server, a history of the versions of the sharing file corresponding to the identifier.

57. The method of claim 52, further comprising:
requesting, by the one or more devices, the sharing file with a specific version stored in the server; and
sending, by the server, the sharing file with the specific version requested by the one or more devices.

58. The method of claim 52, further comprising sending, by the one or more devices, a request for the information of the version of the sharing file in response to execution of the sharing file.

59. The method of claim 52, further comprising outputting or displaying, by the one or more devices, the version of the sharing file with an icon of the sharing file.
